(19) United States
(12) Patent Application Publication
(10) Pub. No.: US 2007/0201390 A1
(43) Pub. Date: Aug. 30, 2007

(54) Apparatus and method for converting MAC frame in broadband wireless access (BWA) system

(75) Inventors: Hyung-Seok Kim, Seoul (KR); Joo-Han Song, Yongin-si (KR); Jung-Yeob Lee, Suwon-si (KR); Bo-Kyung Lee, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/705,569

(22) Filed: Feb. 12, 2007

(30) Foreign Application Priority Data
Feb. 10, 2006 (KR) 10-2006-0013036

(51) Int. Cl. H04B 7/00

(52) U.S. Cl. 370/310.2

(57) ABSTRACT

An apparatus and method for converting a Media Access Control (MAC) frame in a Broadband Wireless Access (BWA) system. The apparatus includes a receiver for receiving an Ethernet MAC frame; a path searcher for extracting a MAC Service Data Unit (SDU) from the Ethernet MAC frame, checking a destination Internet Protocol (IP) address from the extracted MAC SDU, and searching an optimum route by looking up in a routing table; a frame generator for generating a MAC header which includes a MAC address of the route discovered at the path searcher, and generating a wireless MAC frame which includes the MAC header and the MAC SDU; and a transmitter for transmitting the wireless MAC frame generated at the frame generator.

### PRIORITY

This application claims priority under 35 U.S.C. §119 to an application filed in the Korean Intellectual Property Office on Feb. 10, 2006 and assigned Serial No. 2006-13036, the contents of which are incorporated herein by reference.

### BACKGROUND OF THE INVENTION

1. Field of the Invention

The present invention generally relates to an apparatus and method for converting a frame in a Broadband Wireless Access (BWA) system, and in particular, to a conversion apparatus and method without dividing a frame when switching from a wired network to a wireless network.

2. Description of the Related Art

An all Internet Protocol (ALL-IP) network has been suggested to meet various service demands of Internet users using wireless access services. The ALL-IP network transmits data and signaling on an IP basis, separates a bearer function, a control function, and a service function, and provides multimedia communications in real time by using an IP based mobile communication network structure and protocol.

An ALL-IP network can provide services in association with the Internet network by means of the IP, regardless of existing access methods, such as wire telephone, cellular telephone, cable, Local Area Network (LAN), etc., and achieve synergy thanks to IP expansion and cost reduction in service provision.

Additionally, the ALL-IP network can provide a solution suitable for integrated service, which is integrated multimedia service covering voice, data, and real-time video service at one time, enable integrated and low-cost maintenance using IP, and acquire cost reduction through packet transmission. Namely, the ALL-IP network is an IP based integrated network for supporting wire/wireless voice service, wire/wireless Internet service, and wire/wireless multimedia service.

The ALL-IP network uses a converting apparatus for the sake of communications between wired network and wireless networks. A wireless network, which communicates using a conventional third generation (3G) wireless communication system, has a lower transmission rate than a wired network. Hence, a conventional converting apparatus, upon receiving a frame from a wired network, should divide a received frame for transmission to a wireless network, reconstructs the frame in a size supported by the wireless network, and transmits the reconstructed frame to the wireless network.

FIG. 1 shows frame conversion in a conventional converting apparatus. In FIG. 1, (a) is an Ethernet Media Access Control (MAC) frame received over the wired network, which includes a MAC header 100 for the wired network communication, an IP 102, a Transmission Control Protocol (TCP) 104, a payload 106, and a Cyclic Redundancy Check (CRC) 108. (b) is a wireless MAC frame which is generated by dividing the Ethernet MAC frame received over the wired network, to transmit the wireless MAC frame to the wireless network. The wireless MAC frame (b) basically includes MAC headers 110 and 120 for the wireless network communication, frag SHs 112 and 122 indicating the beginning, the end, or the order of the divided frame, and CRCs 114 and 124. The wireless MAC frame (b) includes and stores part of a MAC Service Data Unit (SDU) of the wired MAC frame (a) depending on the size of the allocated area. The MAC SDU of the wired MAC frame (a) includes the IP 102, the TCP 104, and the payload 106.

In general, the conventional wireless network has a frame area allocated to a user, which is smaller than the frame area of the wired network. Hence, the conventional ALL-IP network converting apparatus is subject to overhead when dividing and transmitting the MAC frame from the wired network to the wireless network, and a terminal receiving the divided MAC frames is subject to overhead when combining frames.

Meanwhile, a BWA system is a radio communication system with the channel transmission rate over 2 megabytes per second (Mbps) in mobile and stationary environments based on a radio medium using the broadband of 2 GHz, 5 GHz, 26 GHz, and 60 GHz to support multimedia services, such as voice, data, high definition video, etc. In the BWA system, the size of frame area assignable to a user who accesses in a wireless manner is greater than the conventional 3G wireless network. However, the BWA system does not separately define the structure of the MAC frame by taking into account the frame size. Therefore, what is demanded is a wireless MAC frame structure by taking into account the size allocatable to the user in the BWA system.

### SUMMARY OF THE INVENTION

An aspect of the present invention is to substantially solve at least the above problems and/or disadvantages and to provide at least the advantages below. Accordingly, an aspect of the present invention is to provide an apparatus and method for converting a MAC frame in a BWA system.

Another aspect of the present invention is to provide an apparatus and method for generating a wireless MAC frame including the whole MAC SDU without dividing the MAC SDU of an Ethernet MAC frame when converting the Ethernet MAC frame to the wireless MAC frame in a BWA system.

The above aspects are achieved by providing an apparatus for converting a MAC frame in a BWA system, which includes a receiver for receiving an Ethernet MAC frame; a path searcher for extracting a MAC SDU from the Ethernet MAC frame, checking a destination IP address from the extracted MAC SDU, and searching an optimum route by looking up in a routing table; a frame generator for generating a MAC header which includes a MAC address of the route discovered at the path searcher, and generating a wireless MAC frame which includes the MAC header and the MAC SDU; and a transmitter for transmitting the wireless MAC frame generated at the frame generator.

According to one aspect of the present invention, a method for converting a MAC frame in a BWA system, includes receiving an Ethernet MAC frame; extracting a MAC SDU from the Ethernet MAC frame; checking a destination IP address from the MAC SDU and searching a route to the destination; generating a MAC header which includes a MAC address of the destination according to the route; generating a wireless MAC frame which includes the MAC header and the MAC SDU; and transmitting the wireless MAC frame.

### BRIEF DESCRIPTION OF THE DRAWINGS

The above and other objects, features and advantages of the present invention will become more apparent from the following detailed description when taken in conjunction with the accompanying drawings in which:

FIG. 1 depicts a frame conversion in a conventional converting apparatus;

FIG. 2 depicts an FTP connection structure between a core network server and a terminal in a BWA system according to the present invention;

FIG. 3 depicts a structure of a wireless MAC frame which is generated at a converting apparatus of the BWA system according to the present invention;

FIG. 4 is a block diagram of the converting apparatus of the BWA system according to the present invention; and

FIG. 5 is a flowchart outlining transmission of the wireless MAC frame at the converting apparatus of the BWA system according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

The present invention provides an apparatus and method for converting a frame without dividing it when switching from a wired network to a wireless network in a Broadband Wireless Access (BWA) system.

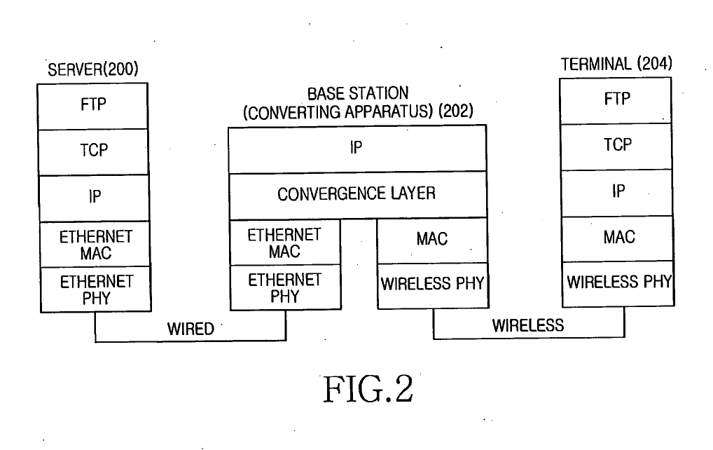

FIG. 2 depicts a File Transfer Protocol (FTP) connection structure between a core network server and a terminal in a BWA system according to the present invention. In FIG. 2, the BWA system includes a server 200, a base station (converting apparatus) 202, and a terminal 204. The FTP, which is the standard protocol for exchanging files between computers over Internet, is one of Transmission Control Protocol/Internet Protocol (TCP/IP) application protocols.

Data transmitted from the server 200 using the FTP is provided to TCP which is the protocol under the FTP in the application layer. The TCP contains connection management information, such as window size information, time-out information, etc., in a header, contains data from the FTP in a payload, and provides them to an IP layer which is the lower protocol. The IP layer generates an IP packet which includes information required for routing between networks in a header (e.g., information such as sender IP address, destination IP address, and delivery IP address acquired from a routing table) in addition to the TCP packet from the TCP layer, and then provides the generated IP packet to a lower Ethernet MAC layer.

According to a protocol (e.g., Address Resolution Protocol (ARP) of IPv4 and Neighbor Discovery Protocol (NDP) of IPv6) which manages the IP address and an Ethernet MAC address used in the Ethernet MAC layer, the Ethernet MAC address for the sender IP address is contained in the header as the sender Ethernet MAC address of the Ethernet MAC frame. The recipient MAC address is the delivery IP address, that is, the Ethernet MAC address of the base station 202. The payload of the Ethernet MAC frame carries the IP frame.

The Ethernet MAC frame generated in the Ethernet MAC layer is provided to a physical layer, converted to an analog signal through the digital modulation and the digital analog modulation, and then provided to a physical layer of the base station 202. Next, the frame goes through the analog digital modulation and the digital demodulation in the physical layer of the base station 202 and then provided to an Ethernet MAC layer of the base station 202.

If the recipient Ethernet MAC address is the same as the MAC address of the base station 202, the Ethernet MAC layer of the base station 202 processes the Ethernet frame. If the two addresses are different from each other, the Ethernet frame is discarded. The Ethernet MAC layer, receiving the Ethernet packet destined for the base station 202, provides it to a convergence layer. Upon receiving the Ethernet MAC frame, the convergence layer provides the IP frame to an upper IP layer.

Receiving the IP frame, the IP layer of the base station 202 checks a destination IP address, discovers a delivery IP address on an optimum path by looking up the optimum path for the destination IP address in a routing table, and then provides the IP frame including the delivery IP address to a convergence layer. The convergence layer is a layer where a protocol which manages information for converting the frame from the IP layer to a MAC frame of the wireless network, e.g., a MAC address and an IP address of a wireless network node, operates. In other words, the convergence layer sets the wireless MAC address corresponding to the delivery IP address as the destination MAC address and provides the frame to a lower wireless network MAC layer.

Based on the information provided from the convergence layer, the wireless network MAC layer sets the destination wireless MAC address to a wireless MAC address of the terminal 204 and provides the generated MAC frame to a physical layer. The generated wireless MAC frame contains the whole MAC SDU of the received Ethernet MAC frame.

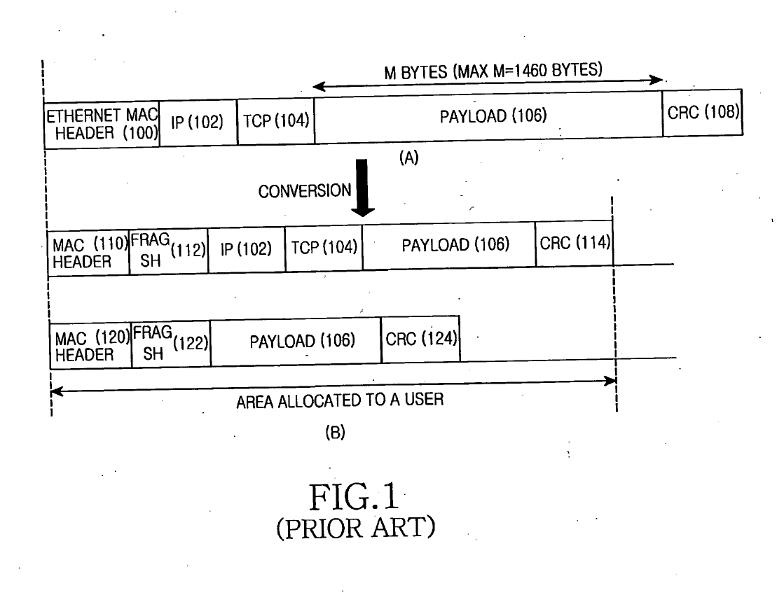

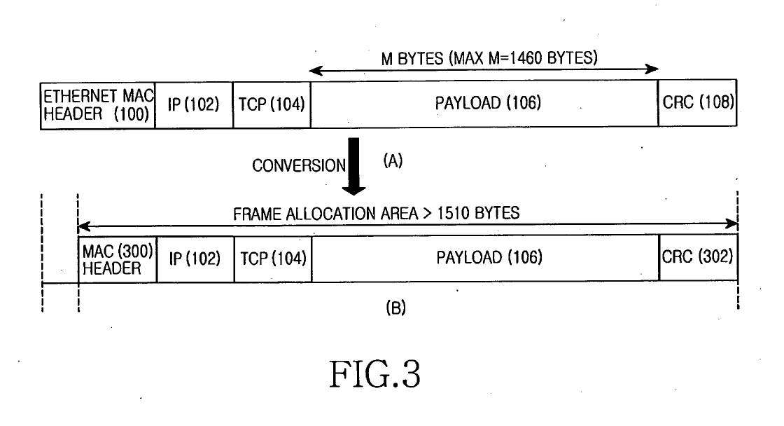

FIG. 3 depicts a structure of the wireless MAC frame which is generated at the converting apparatus of the BWA system according to the present invention. An Ethernet MAC frame (a) is generated at the server 200 and transmitted to the base station 202 over the core network, which is the same as the Ethernet MAC frame (a) of FIG. 1. A wireless MAC frame (b) includes the whole MAC SDU of the Ethernet MAC frame (a). The wireless MAC frame (b) includes a wireless MAC header 300, the MAC SDU of the Ethernet MAC frame (a), and a CRC 302 for error detection. The MAC SDU of the Ethernet MAC frame (a) includes an IP 102, a TCP 104, and a payload 106. In FIG. 3, as one can see, the wireless MAC frame (b) contains the whole SDU of the Ethernet MAC frame (a). In detail, even when the payload of the Ethernet MAC frame (a) is 1460 bytes in size at maximum, the payload of the wireless MAC frame (b) can be constructed to contain the whole payload without dividing it. The Ethernet MAC frame (a) includes 1518 bytes at maximum including the Ethernet header (14 bytes) and the SDU (46 bytes at minimum to 1500 bytes at maximum including the IP 102, the TCP 104, and the payload 106) and the CRC (4 bytes), whereas the wireless MAC frame (b) includes 1510 bytes or more including the wireless MAC header (6 bytes) and the SDU (46 bytes at minimum to 1500 bytes at maximum) and the CRC (4 bytes).

The physical layer converts the received wireless MAC frame to an analog signal through the digital modulation and the digital analog demodulation, and provides the analog signal to a physical layer of the terminal 204 over the wireless network.

The frame received at the physical layer of the terminal 204 is provided to a wireless MAC layer of the terminal 204 after going through the analog digital modulation and the digital demodulation. The wireless MAC layer of the terminal 204 provides its upper IP layer with the payload of the MAC frame received from the base station 202. When a delivery IP address of the IP packet is the same as the destination IP address, the IP layer recognizes that it is the frame destined for the terminal 204 itself and provides an upper TCP layer with the TCP frame which is the payload of the IP packet. The TCP layer executes a function such as connection management contained in the header of the TCP frame and provides its upper FTP layer with the FTP frame which is the payload. Receiving the FTP frame, the FTP layer receives the data from the server 200. This process is performed when the server 200 transmits the FTP frame to the terminal 204. If the terminal 204 transmits the FTP frame to the server 200, the reverse process is executed.

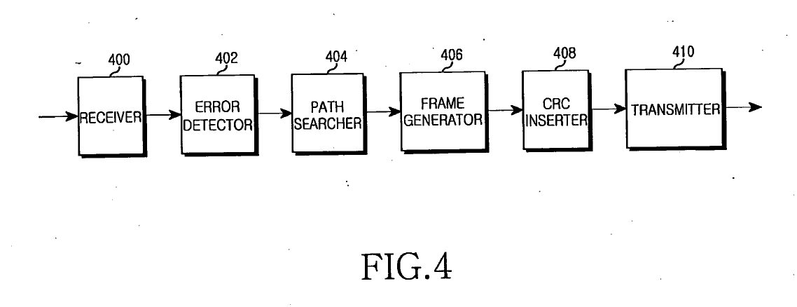

FIG. 4 shows a converting apparatus of the BWA system according to the present invention. The converting apparatus includes a receiver 400, an error detector 402, a path searcher 404, a frame generator 406, an CRC inserter 408, and a transmitter 410.

The receiver 400 serves to receive the Ethernet MAC frame from the server over the core network connected by cable. The error detector 402 detects error using the CRC of the received Ethernet MAC frame. When there is no error, the error detector 402 provides the Ethernet MAC frame to the path searcher 404. The path searcher 404 extracts the MAC SDU from the frame, checks the destination IP address using the extracted MAC SDU, looks up in the routing table to find an optimum route for the destination IP address, and retrieves the delivery IP address on the optimum address. The frame generator 406 retrieves the destination MAC address using the delivery IP address and generates the wireless MAC frame which includes the wireless MAC header with the retrieved destination MAC address and the MAC SDU extracted from the Ethernet MAC frame. The wireless MAC frame is in size covering the whole MAC SDU extracted from the Ethernet MAC frame. The structure of the wireless MAC frame is shown in (b) of FIG. 3.

The CRC inserter 408 generates a CRC for extracting error from the frame generated at the frame generator 406 and appends the CRC to the frame. The transmitter 410 transmits the wireless MAC frame to the destination terminal over the wireless network.

The following explanation describes a method for converting the Ethernet MAC frame to the wireless MAC frame in the converting apparatus of the BWA system by referring to the drawing.

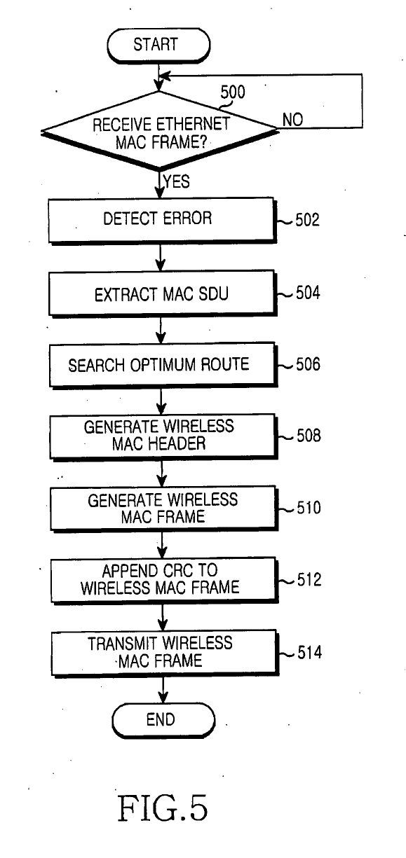

FIG. 5 outlines transmission of the wireless MAC frame at the converting apparatus of the BWA system according to the present invention. When receiving an Ethernet MAC frame in step 500, the converting apparatus detects error using the CRC of the received Ethernet MAC frame in step 502. After the error detection, the converting apparatus extracts from the Ethernet MAC frame the MAC SDU including the IP 102, the TCP 104, and the payload 106 in step 504.

The converting apparatus checks the destination IP from the extracted MAC SDU and searches a route to the destination in step 506, generates a wireless MAC header containing the destination MAC address according to the discovered route in step 508, and generates a wireless MAC frame including the whole extracted MAC SDU in step 510. Next, the converting apparatus generates an CRC for the error detect and appends the CRC to the wireless MAC frame in step 512, and then transmits the generated wireless MAC frame in step 514.

As set forth above, when switching from the wired network to the wireless network in the BWA system, the apparatus and the method of the present invention can convert the frame without dividing it. When transmitting the MAC frame from the wired network to the wireless network, it is possible to reduce the overhead when dividing and transmitting the MAC frame and the overhead when receiving and combining the divided MAC frame.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. An apparatus for converting a Media Access Control (MAC) frame in a Broadband Wireless Access (BWA) system, comprising:
a receiver for receiving an Ethernet MAC frame;
a path searcher for extracting a MAC Service Data Unit (SDU) from the Ethernet MAC frame, checking a destination Internet Protocol (IP) address from the extracted MAC SDU, and searching an optimum route by looking up in a routing table;
a frame generator for generating a MAC header which includes a MAC address of the route discovered at the path searcher, and generating a wireless MAC frame which includes the MAC header and the MAC SDU; and
a transmitter for transmitting the wireless MAC frame generated at the frame generator.

2. The apparatus of claim 1, wherein the whole Ethernet MAC SDU is included in the wireless MAC frame without dividing the Ethernet MAC SDU even when a payload in the MAC SDU is of a maximum size.

3. The apparatus of claim 1, further comprising:
an error detector for detecting error using a Cyclic Redundancy Check (CRC) of the Ethernet MAC frame before the Ethernet MAC frame received at the receiver is provided to the path searcher.

4. The apparatus of claim 1, further comprising:
an CRC inserter for, before the wireless MAC frame is generated and transmitted, generating a CRC to extract error from the wireless MAC frame and appending the CRC to the frame.

5. The apparatus of claim 1, wherein the wireless MAC frame includes the MAC header and the whole MAC SDU being undivided.

6. The apparatus of claim 5, wherein the MAC SDU includes an IP, a Transmission Control Protocol (TCP) and a payload.

7. The apparatus of claim 1, wherein 1510 bytes or more are allocatable to the wireless MAC frame in size.

8. A method for converting a Media Access Control (MAC) frame in a Broadband Wireless Access (BWA) system, comprising:
receiving an Ethernet MAC frame;
extracting a MAC service data unit (SDU) from the Ethernet MAC frame;
checking a destination Internet Protocol (IP) address from the MAC SDU and searching a route to the destination;
generating a MAC header which includes a MAC address of the destination according to the route;
generating a wireless MAC frame which includes the MAC header and the MAC SDU; and
transmitting the wireless MAC frame.

9. The method of claim 8, wherein the wireless MAC frame includes the whole Ethernet MAC SDU without dividing the Ethernet MAC SDU even when a payload in the MAC SDU is of a maximum size.

10. The method of claim 8, further comprising:
detecting error using a Cyclic Redundancy Check (CRC) of the Ethernet MAC frame when the Ethernet MAC frame is received.

11. The method of claim 8, further comprising:
before generating and transmitting the wireless MAC frame, generating a CRC to extract error from the wireless MAC frame and appending the CRC to the frame.

12. The method of claim 8, wherein the wireless MAC frame includes the MAC header and the whole MAC SDU being undivided.

13. The method of claim 12, wherein the MAC SDU includes an IP, a Transmission Control Protocol (TCP) and a payload.

14. The method of claim 8, wherein at least 1510 bytes are allocatable to the wireless MAC frame in size.

15. An apparatus for converting a Media Access Control (MAC) frame in a wireless system, comprising:
means for extracting a MAC service data unit (SDU) from a received Ethernet MAC frame;
means for checking a destination Internet Protocol (IP) address from the MAC SDU and searching a route to the destination;
means for generating a MAC header which includes a MAC address of the destination according to the route; and
means for generating a wireless MAC frame which includes the MAC header and the MAC SDU.

16. A method for converting a Media Access Control (MAC) frame in a wireless system, comprising:
extracting a MAC service data unit (SDU) from a received Ethernet MAC frame;
checking a destination Internet Protocol (IP) address from the MAC SDU and searching a route to the destination;
generating a MAC header which includes a MAC address of the destination according to the route; and
generating a wireless MAC frame which includes the MAC header and the MAC SDU.
